(19) United States
(12) Patent Application Publication
(10) Pub. No.: US 2011/0102328 A1
(43) Pub. Date: May 5, 2011

(54) Hyper folding portable electronic device

(76) Inventor: Tonny Chen, Shengang Shiang (TW)

(21) Appl. No.: 12/588,979

(22) Filed: Nov. 4, 2009

(51) Int. Cl. G06F 3/02

(52) U.S. Cl. 345/169

(57) ABSTRACT

A hyper folding portable electronic device and particularly an electronic device adopted for handheld operation to facilitate manual data entry mainly has a chassis supported by user's thumbs and input operation performed user's rest fingers. The electronic device includes a first body holding an operation key cluster and a second body holding a screen that are coupled through a hinge structure. The first body and second body are flappable at a selected angle so that the screen and the operation key cluster are positioned in a back-to-back manner. The screen displays a keyboard table corresponding to the operation key cluster to facilitate user's data entry operation.

### BACKGROUND OF THE INVENTION

1. Field of the Invention

The present invention relates to a hyper folding portable electronic device and particularly to an electronic device adopted for handheld operation to facilitate manual data entry.

2. Description of the Prior Art

These days portable computers have become an important focus in computer industry. Almost all manufacturers have devoted a great deal of investment to develop portable computers to make them usable anytime anywhere. Power lasting time and performance are necessary consideration factors. These have to rely on power saving elements developed by semiconductor industry and higher capacity batteries developed by battery producers. However, greater portability to free the constraint of physical operation site has to rely on the design of computer manufacturers. The present notebook computers generally adopt two-piece folding structure with one piece for a computer screen and other piece for a keyboard. The two pieces can be positioned about perpendicular with each other to be rested on a table to facilitate operation. But such a design makes handheld operation difficult. To meet handheld operation requirement the present design usually adopts tablet computer. The tablet computer has the screen located on the chassis so that an user can hold the computer with one hand and hold a stylus with other hand to select function keys or write contents on a touch screen.

Although the tablet computer makes handheld operation easier, many important computer works involve data entry. The main data entry means provided by the tablet computer is the stylus. Its operation is slower and more tedious than the conventional keyboard data entry. Hence although the tablet computer provides improvement on portability, slower input is a big drawback. As a result it is not widely accepted on the market, and its applications are limited to special fields such as doctor's touring wards, checking inventory stock and the like that require only ticking selected items with no much data entry.

To remedy the data entry problem of the tablet computer some producers offer a design which has a fan type keyboard table on the touch screen to allow an user to hold the computer with both hands and perform depressing action with thumbs. Due to the user has to hold the computer with both hands and the moving range of the thumbs is limited, and thumb operation also is more cumbersome, operation speed is much slower than through the ordinary keyboard.

There is another design which adopts a sliding keyboard. When a great deal of data entry is needed a keyboard hidden inside the computer can be moved out for use. However, it also functions like the keyboard table on a touch screen, and requires an user to hold the computer with fingers other than the thumbs and perform operation through the awkward thumbs. When the handheld portion is on the keyboard and the screen is extended rearwards, the gravity center of the computer is located outside user's two hands. Holding the computer becomes tiresome and cannot last a long time.

To overcome the aforesaid problems the operation keys and the screen have to be positioned back to back, with the screen keyboard table corresponding to the keys at the back side, and each key has to be equipped with a tactile sensor so that user's eyes can determine the key layout at the back side by looking at the keyboard table on the screen, and the tactile sensor on the key can transfer the finger position to the screen. The chassis may be designed like an inverse V-shape to allow user's thumbs to wedge in the inverse V-shape space to support the weight of the chassis. Then the rest fingers other than the thumbs can be freed to perform operation on the keyboard keys at the outer side of the chassis.

### SUMMARY OF THE INVENTION

Therefore it is an object of the present invention to provide a hyper folding portable electronic device that is especially desirable for handheld operation to do manual data entry. The electronic device according to the invention includes a chassis which has a first body to hold an operation key cluster and a second body to hold a screen, and a hinge structure to couple the two. The device can be turned and adjusted at a selected angle so that the screen at the second body and the operation key cluster at the first body are flipped at a back-to-back position. The screen displays a keyboard table corresponding to the operation key cluster. By means of such a structure user's thumbs can be positioned between the first body and the second body to bear the total weight of the chassis, while the rest fingers can be freely moved on the operation key cluster to perform operation. Thus data entry can be performed rapidly on the handheld device.

In one aspect the operation key cluster has at least one key with a touch pad located thereon to detect touch of a user's finger, and transmit and display a touch signal on the keyboard table on the screen.

In another aspect the touch pad on the key has coordinates divided into a plurality of character zones to allow a number of character symbols to be entered. The character symbols are mapped on the keyboard table on the screen corresponding to their positions. Finger touch signal is transmitted and displayed on the keyboard table. When the finger touches different character zones the corresponding characters or functions represented by the keyboard table are entered.

In yet another aspect the device can be coupled and flipped at a desired angle through the hinge structure. The first body and the second body can be unfolded from a folding condition to a positive use direction (approximate 90 degrees) with the screen and the operation key cluster positioned in a face-to-face manner so that it can be rested on a table like a general notebook computer. The layout of the operation key cluster is same as that of the character symbols of the keyboard table on the screen.

In still another aspect the coupled and flipped angle can be adjusted through the hinge structure. The first body and the second body may be flipped outwards in a back-to-back manner at another use angle (maximum backward flipping angle). The screen and the operation key cluster are positioned in a back-to-back manner to allow user to operate in a handheld manner. The layout of keys of the operation key cluster forms a mirror image against the character symbols of the keyboard table on the screen, with the same relationship up and down, but an inverse relationship left and right.

In yet another aspect the hinge structure has a single axle, and the first body and the second body have a thinner portion adjacent to the hinge structure. The second body with the screen located thereon and the first body with the operation key cluster located thereon can be folded in a face-to-face manner, and also may be unfolded and flipped backwards at an angle at least 270 degrees so that the front side of the screen and the operation key cluster are positioned in a back-to-back manner at an included angle smaller than 90 degrees.

In yet another aspect the hinge structure has dual axles including a first axle and a second axle that are turnable for 180 degrees or more. The first body and the second body can be folded in a face-to-face manner, and also may be unfolded and flipped backwards at an angle approximate 360 degrees or more so that the front side of the screen and the back side of the operation key cluster are positioned substantially in a parallel manner.

In yet another aspect the screen may be an external screen connecting to the hyper folding portable electronic device through a wired or wireless fashion. The coupling structure is same as the ones previously discussed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a schematic view of the key structure of the invention.

FIG. 3 is a schematic view of the keyboard table of the invention.

FIG. 4 is a schematic view of the invention in a folding condition.

FIG. 5 is a schematic view of the invention at a use angle by flipping backwards to a back-to-back position.

FIG. 6 is a schematic view of another embodiment of the invention in a folding condition.

FIG. 7 is a schematic view of another embodiment of the invention at another use angle by flipping in a positive direction.

FIG. 8 is a schematic view of another embodiment of the invention at another use angle by flipping backwards.

FIG. 9 is a perspective view of another embodiment of the invention at another use angle by flipping backwards.

FIG. 10 is a schematic view of the invention showing the layout relationship between the screen keyboard table and the operation key cluster.

FIG. 11 is another schematic view of the invention showing the layout relationship between the screen keyboard table and the operation key cluster.

FIG. 12 is a perspective view of the invention connecting to an external screen through a wired fashion.

FIG. 13 is a perspective view of the invention connecting to an external screen through a wireless fashion.

### DESCRIPTION OF THE PREFERRED EMBODIMENTS

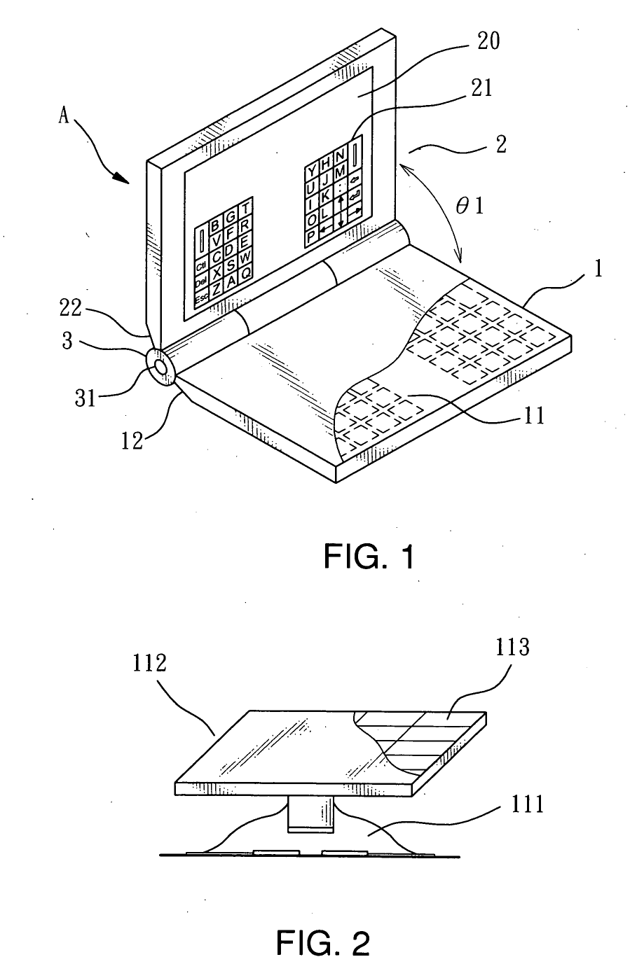

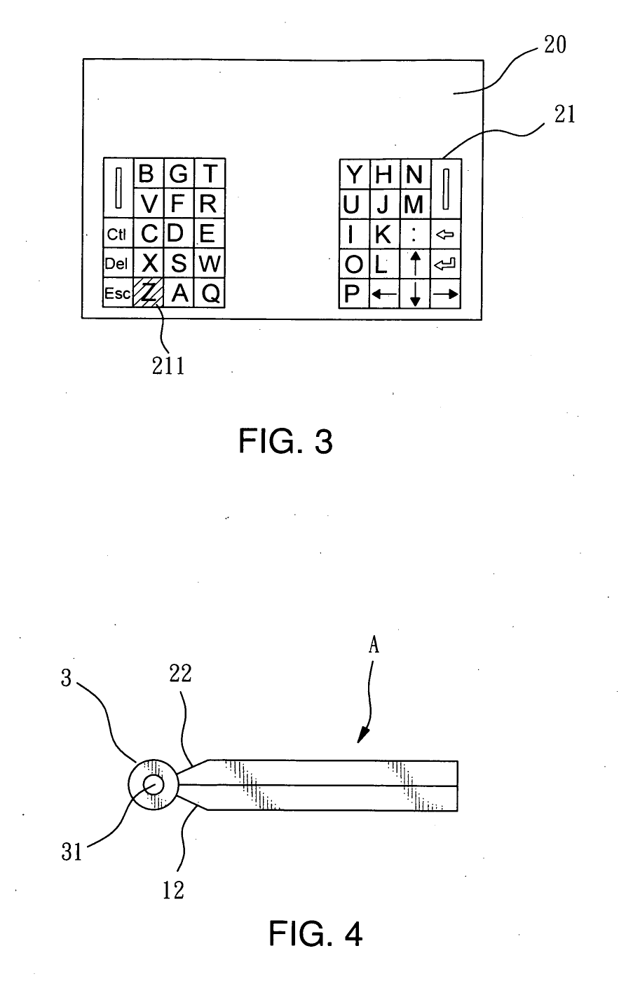

Please referring to FIGS. 1, 2 and 3, the hyper folding portable electronic device according to the invention includes a chassis A which has a first body 1 holding an operation key cluster 11 (at one side of the first body 1) and a second body 2 holding a screen 20 (at one side of the second body 2) that are coupled through a hinge structure 3.

The operation key cluster 11 on the first body 1 has at least one key 111 with a touch pad 112 located thereon to detect user's finger contact. The touch pad 112 has coordinates divided into a plurality of character zones 113. When a different character zone 113 is touched by the finger a different corresponding character or function on a keyboard table 21 on the screen 20 is entered.

The screen 20 on the second body 2 can display the keyboard table 21 corresponding to the operation key cluster 11 and transmit and display a finger contact signal of a corresponding character (or function) on the screen 20 through an inverse color or blinking fashion to inform the user.

The hinge structure 3 has one axle 31 to couple the first body 1 and the second body 2 to adjust an angle formed between them, and enable the screen 20 and the operation key cluster 11 to be flipped in a back-to-back manner.

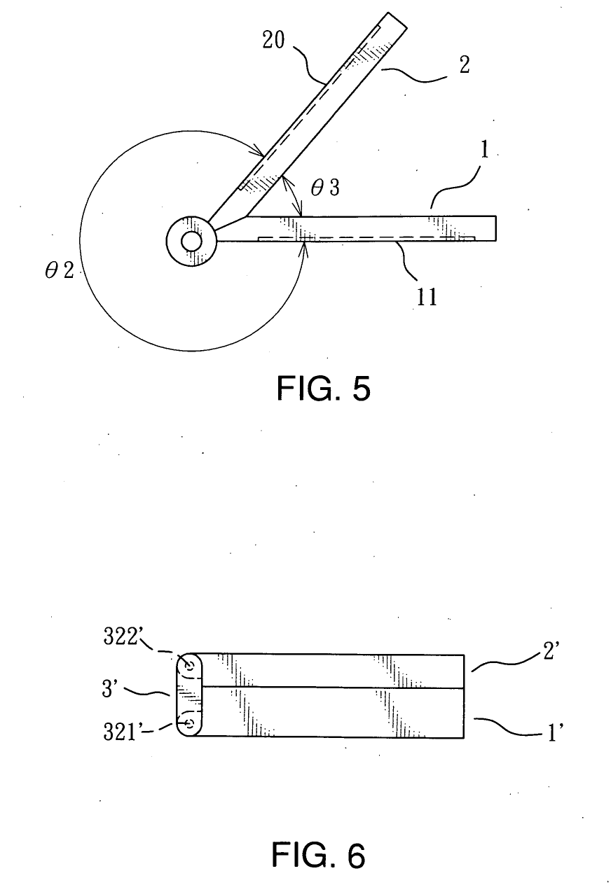

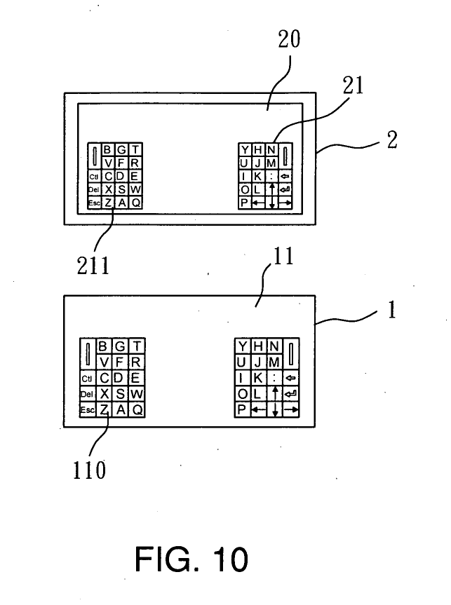

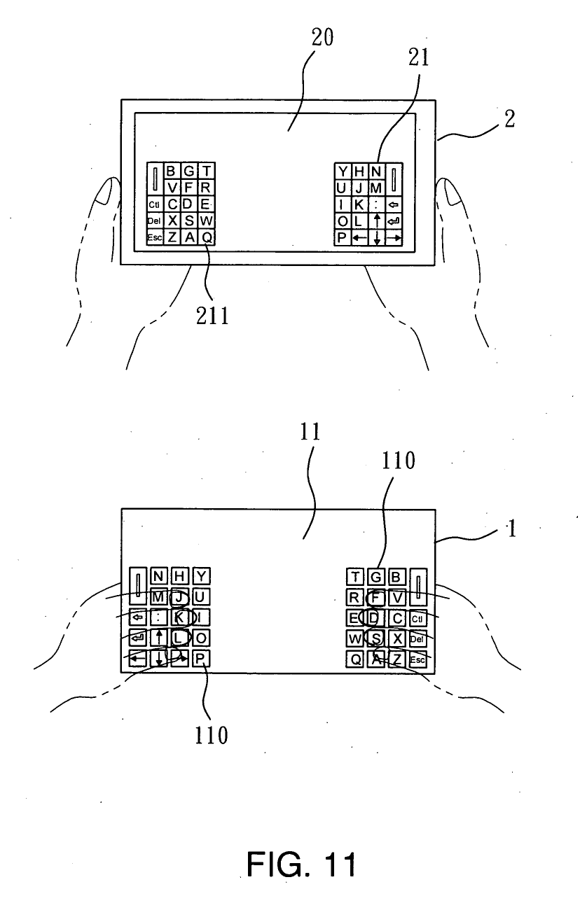

Refer to FIGS. 1, 4 and 5 for a first embodiment of the invention. The second body 2 and the first body 1 adjacent to the hinge structure 3 have respectively one side 22 and 12 formed thinner than other portions. Hence the second body 2 and the first body 1 may be folded face to face, or unfolded face to face at an use angle θ1 (approximate 90 degrees as shown in FIG. 1) to be rested on a table top like a general notebook computer. The screen 20 and operation key cluster 11 function like those of the notebook computer resting on the table top. The operation key cluster 11 has keys 110 laid in the same way as the character symbols 221 on the keyboard table 21 on the screen 20 (referring to FIG. 10). When there is a desire to use the invention in a handheld manner, the second body 2 may be flipped backwards at another use angle θ2 (referring to FIG. 5) for at least 270 degrees and the second body 2 and the first body 1 are positioned in a back-to-back manner to form a space between them at an included angle θ3. Then user's thumbs can be wedged in the space to support the chassis A, and the rest fingers can perform operation on the operation key cluster 11 to do data entry. The included angle θ3 is less than 90 degrees. With the screen 20 and the operation key cluster 11 are at the back-to-back position the layouts of the keys 110 of the operation key cluster 11 and the character symbols 211 of the keyboard table 21 on the screen 20 are formed in a mirror image (referring to FIG. 11) with a same up and down relationship but inverse left and right relationship to enable user to do data entry with two hands while holding the chassis A.

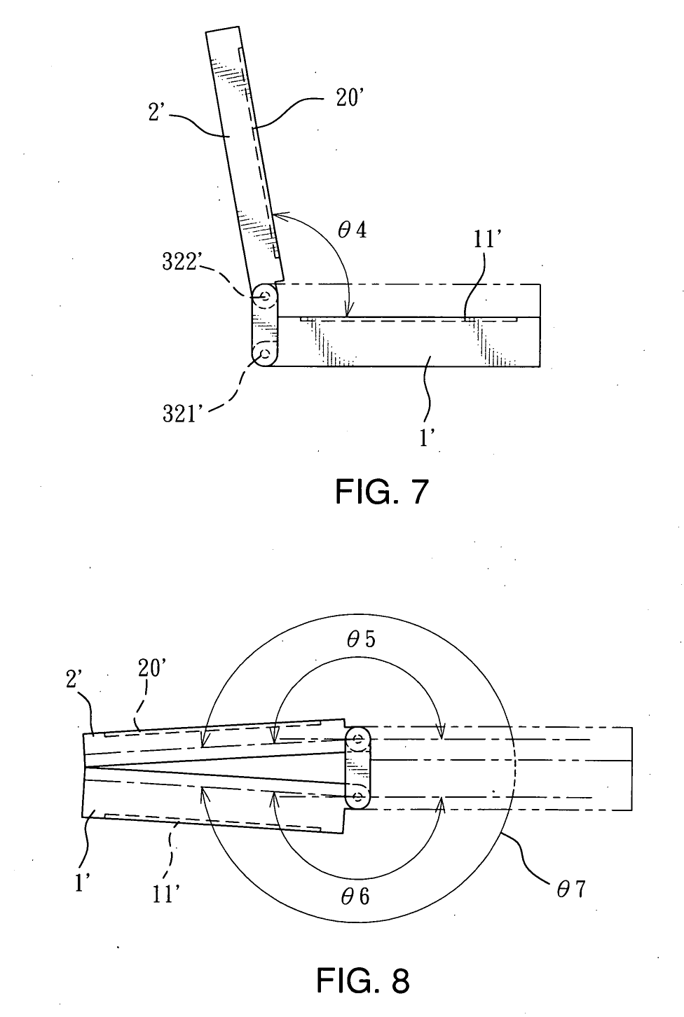

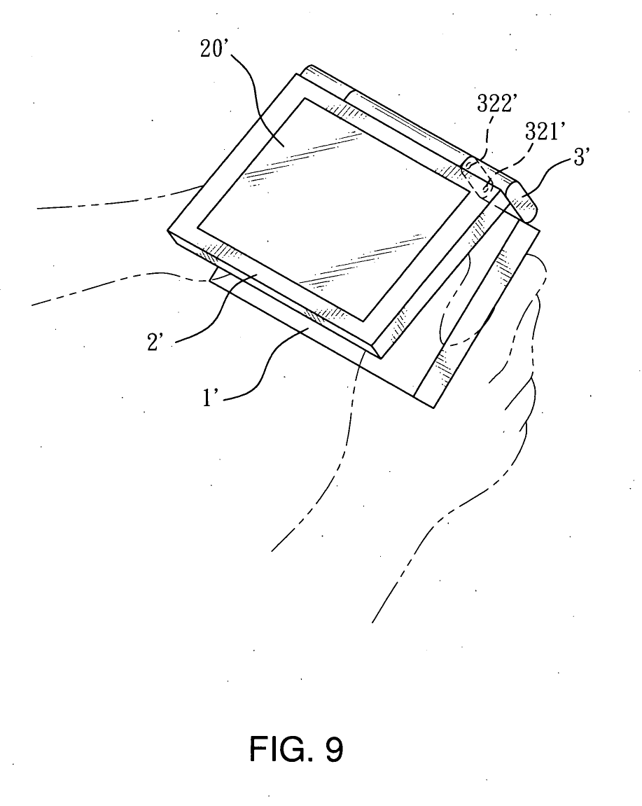

Refer to FIG. 6 for a second embodiment of the invention. The hinge structure 3′ has dual axles that include a first axle 321′ and a second axle 322′. The second body 2′ with the screen 20′ located thereon can be turned and flipped about the second axle 322′ from a folding condition to a positive use angle θ4 (approximate 90 degrees) like a general notebook computer resting on a table top in use (referring to FIG. 7). It also may be formed in a handheld condition by flipping respectively the first body 1′ and second body 2′ about the first axle 321′ and the second axle 322′ at an angle of θ5 and θ6 which can be 180 degrees or more in a maximum condition so that the second body 2′ and first body 1′ can be folded in a face to face manner, or flipped backwards at a use angle θ7 which may be 360 degrees or more (referring to FIGS. 8 and 9) with the screen 20′ on the second body 2′ and the operation key cluster 11′ on the first body 1′ laid back-to-back in substantially a parallel manner.

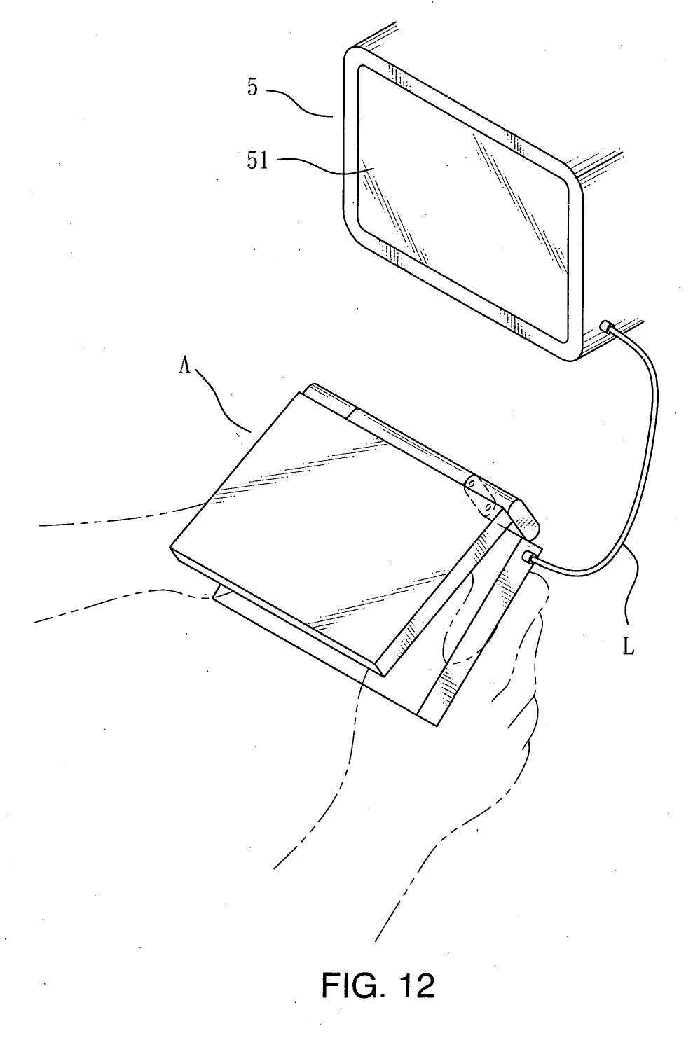

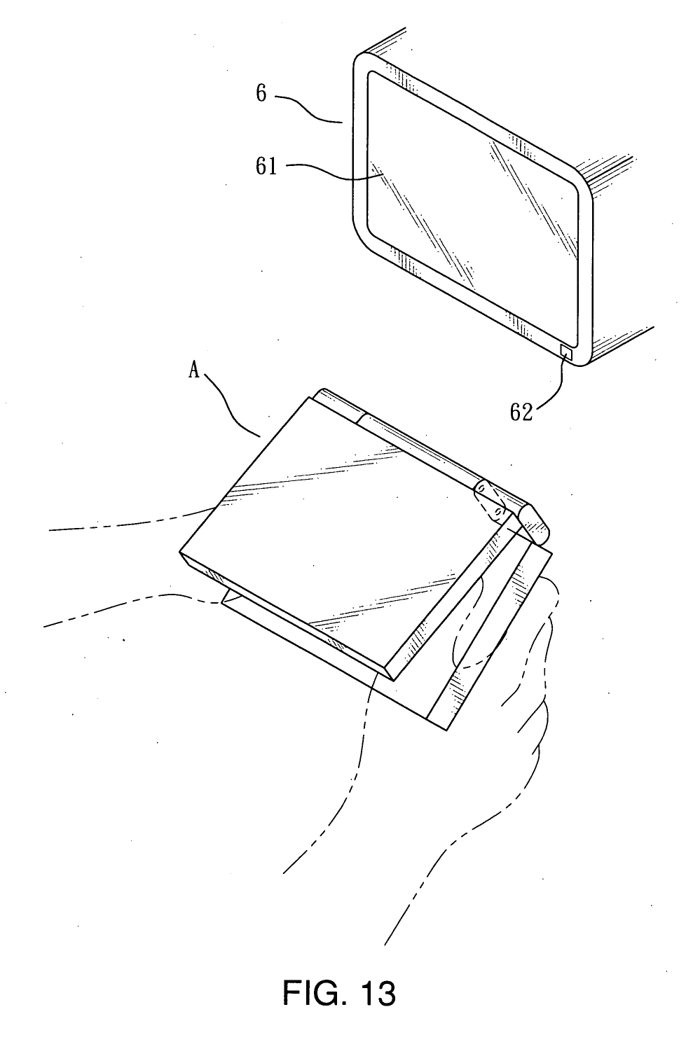

The screens 20 and 20′ in the previous embodiments may also be replaced by an external screen (referring to FIG. 12) which is connected through a wired means. Namely the chassis A can be connected to another electronic device 5 with another screen 51 located thereon through a conductive wire L. The connection also may be made through a wireless means (referring to FIG. 13) in which the invention contains a wireless transmission means (not shown in the drawing) to be connected to yet another electronic device 6 with yet another screen 61 and another wireless transmission means 62 located thereon (wireless transmission is a technique known in the art, thus details are omitted herein). The external screen shown in FIGS. 12 and 13 aim to substitute the screen on the chassis of the invention, and also can display the keyboard table corresponding to the operation key cluster. Operation of flipping the first body and second body and the structure thereof are substantially same as previously discussed, thus details are omitted.

As a conclusion, the hyper folding portable electronic device of the invention can be easily held by users with hands to do data entry with both hands. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A hyper folding portable electronic device comprising a chassis which has a first body and a second body and a hinge structure to couple the first body and the second body; wherein:
the first body has an operation key cluster at one side corresponding to a keyboard table displayed on a screen, the first body and the second body being flippable at a selected angle which is adjustable through the hinge structure, the one side where the operation key cluster is located being an outer side of the first body after flipping to form a back-to-back position with the second body at an included angle with a space formed between them to allow an user's thumbs to be wedged in to support the chassis and user's rest fingers to be operable on the operation key cluster to perform data entry.

2. The hyper folding portable electronic device of claim 1, wherein the keyboard table displayed on the screen has character symbols arranged in a mirror image fashion against keys of the operation key cluster.

3. The hyper folding portable electronic device of claim 1, wherein the second body has a screen at an outer side to form a back-to-back relationship with the operation key cluster.

4. The hyper folding portable electronic device of claim 1, wherein the first body and the second body are flippable in a positive used direction at an angle about 90 degrees and the screen and the operation key cluster face each other and the operation key cluster has keys arranged in a fashion same as a character symbol layout of the keyboard table on the screen.

5. The hyper folding portable electronic device of claim 1, wherein the first body and the second body are flippable backwards against each other at an use angle at least 270 degrees and at an included angle less than 90 degrees such that the screen and the operation key cluster are positioned in a back-to-back manner.

6. The hyper folding portable electronic device of claim 1, wherein the hinge structure has one axle.

7. The hyper folding portable electronic device of claim 1, wherein the hinge structure has two axles including a first axle and a second axle.

8. The hyper folding portable electronic device of claim 1, wherein the operation key cluster has at least one key which has a touch pad located thereon to detect user's finger contact and transmit and display a finger contact signal on the screen.

9. The hyper folding portable electronic device of claim 7, wherein the first axle and the second axle are turnable greater than 180 degrees so that a backward use angle greater than 360 degrees is formed to allow the first body and the second body to be folded by facing each other and flipped to the backward use angle with the screen being substantially parallel with the operation key cluster in a back-to-back manner.

10. The hyper folding portable electronic device of claim 1, wherein the screen is an external screen.

11. The hyper folding portable electronic device of claim 10, wherein the external screen is connected to the chassis in a wired fashion.

12. The hyper folding portable electronic device of claim 10, wherein the external screen is connected to the chassis in a wireless fashion.
